(19) United States
(12) Patent Application Publication
(10) Pub. No.: US 2012/0144678 A1
(43) Pub. Date: Jun. 14, 2012

(54) FOLDABLE PUTTY KNIFE

(76) Inventor: Shou-Hung CHEN, Taipei City (TW)

(21) Appl. No.: 13/175,152

(22) Filed: Jul. 1, 2011

(30) Foreign Application Priority Data
Dec. 10, 2010 (TW) 099224036

(51) Int. Cl. B26B 1/04; B05C 11/04

(52) U.S. Cl. 30/161

(57) ABSTRACT

A foldable putty knife comprises a hollow handle, a knife body, an elastic stopper, a stopper-releasing button, and an elastic piece. The knife body is pivotally connected to the hollow handle's interior and is provided with two positioning notches respectively at two sides adjacent to the pivotally connected end. The elastic stopper is adapted for being engaged with one of the two positioning notches. The stopper-releasing button is fitted into the first hole in the way that its bottom is against the elastic stopper's top. The elastic piece is provided inside the hollow handle. The knife body, under the condition of being located within the hollow handle, can be ejected out of the hollow handle by means of the elastic force provided by the elastic piece after the stopper-releasing button is pressed to compress the elastic stopper and thus detach the elastic stopper from the engaged positioning notch.

### TECHNICAL FIELD

The present invention relates to a putty knife and, more particularly, to a foldable putty knife comprising an elastic stopper, a stopper-releasing button, and an elastic piece, where the limitation exerted on the knife body by the elastic stopper can be removed by pressing the stopper-releasing button, so that the knife body can be ejected out by the elastic force provided from the elastic piece, all of which make it more convenient to use.

### BACKGROUND

During building constructions, putty knives are instruments for removing paint residues on walls and are commonly used by masons. In an aspect regarding structure, conventional putty knives are designed to be either non-foldable ones or foldable ones. Among these, foldable putty knives are far more advantageous because of desired properties of compactness, convenience for carrying, and better safety.

A conventional putty knife principally comprises a casing and a knife body. The knife body has one end pivotally connected to the casing. Thereby, the knife body can be moved out of the casing for use or moved back into the casing for storage. For purpose of safety, one major consideration is how to hold the knife body firmly inside the casing when the putty knife is not in use.

Regarding the structural design for a foldable putty knife, the knife body is kept inside the casing by means of an engagement structure. For example, corresponding engaging elements can be respectively provided at the knife body and the casing. In this way, when the knife body is moved into the casing, the knife body can be securely held inside the casing by engaging the corresponding elements with each other.

Above-mentioned corresponding engaging elements are usually designed to be capable of being separated manually in order to facilitate users to detach the engaging elements. Although convenience is of significance for users, far more attention are paid to the consideration of safety than convenience. As a result, the knife body should be kept firmly in the casing when not in use. However, the more firmly the knife body is kept inside the casing, the more inconvenient it will be to move the knife body out of the casing.

Moreover, above-mentioned engagement structure is mainly used to hold the knife body securely inside the casing for storage. After the engagement is released, however, the knife body is still to be moved manually out of the casing by users. For safety consideration, the engagement between the knife and the casing must be in an accepted firmness. In this case, the firmer the engagement is, the more difficult it is to move the knife body manually out of the casing. If excessive force is required to move the knife body out of the casing, users will be at more risk of injuring their hands.

In order to overcome above shortcomings, inventor had the motive to study and develop the present invention. After hard research and development, the inventor provides a foldable putty knife, while the knife body can be securely kept in the hollow handle, the knife body also can be released by pressing stopper-releasing button and ejected out of the hollow handle automatically by elastic force provided by the elastic piece.

### SUMMARY OF THE DISCLOSURE

An object of the present invention is to provide a foldable putty knife of convenient use, where the knife body can be released simply by pressing the stopper-releasing button and can be ejected automatically out of the hollow handle by elastic force provided by the elastic piece.

Another object of the present invention is to provide a foldable putty knife, the knife body of which is provided with a nail-drawing hole. By means of this design, no extra nail-drawer is required during the process of building construction. Thereby, the foldable putty knife is not only convenient for use, but it is also versatile.

In order to achieve above objects, the present invention provides a foldable putty knife comprising a hollow handle, a knife body, an elastic stopper, a stopper-releasing button, and an elastic piece. The hollow handle has one end and two lateral sides, where on the top of that end is provided with a first hole, and the two lateral sides are respectively provided with an opening. One end of the knife body is pivotally connected to the hollow handle's interior via a shaft. Besides, the knife body has two positioning notches that are respectively provided at two sides adjacent to the pivotally-connected end. The elastic stopper is provided inside the hollow handle and adapted for being engaged with one of the two positioning notches. The stopper-releasing button is fitted into the first hole in the way that its bottom is against the elastic stopper's top for compressing the elastic stopper in order to detach the elastic stopper from the engaged positioning notch. The elastic piece is provided inside the hollow handle and adapted for providing elastic force to move the knife body out of the hollow handle.

In implementation, the knife body is further provided with a nail-drawing hole.

The following detailed description, given by way of examples or embodiments, will best be understood in conjunction with the accompanying drawings.

### BRIEF DESCRIPTION OF THE DRAWINGS

FIG. 1 shows an exploded perspective view of a foldable putty knife of the present invention.

FIG. 2A shows a perspective view of the foldable putty knife of the present invention.

FIG. 2B shows another perspective view of the foldable putty knife of the present invention.

FIG. 3 shows a topside view of the foldable putty knife of the present invention.

FIG. 4 shows a cross-sectional view of FIG. 3 along aa′ line.

FIG. 5A shows an enlarged view of the area B in FIG. 4.

FIG. 5B shows another cross-sectional view of the foldable putty knife of the present invention.

FIGS. 6A-6D show the use of the foldable putty knife of the present invention.

### DETAILED DESCRIPTION

The present invention discloses a foldable putty knife comprising a hollow handle, a knife body, an elastic stopper, a stopper-releasing button, and an elastic piece. The hollow handle has one end and two lateral sides, where on the top of the end is provided with a first hole, and the two lateral sides are respectively provided with an opening. One end of the knife body is pivotally connected to the hollow handle's interior via a shaft. Besides, the knife body has two positioning notches that are respectively provided at two sides adjacent to the pivotally-connected end. The elastic stopper is provided inside the hollow handle and adapted for being engaged with one of the two positioning notches. The stopper-releasing button is fitted into the first hole in the way that its bottom is against the elastic stopper's top for compressing the elastic stopper in order to detach the elastic stopper from the engaged positioning notch. The elastic piece is provided inside the hollow handle and adapted for providing elastic force to move the knife body out of the hollow handle.

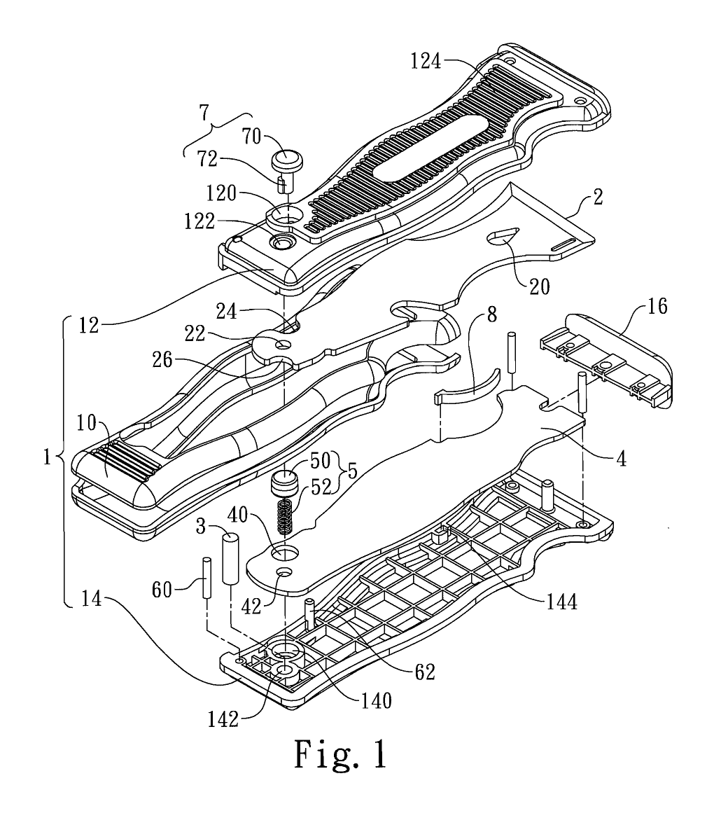

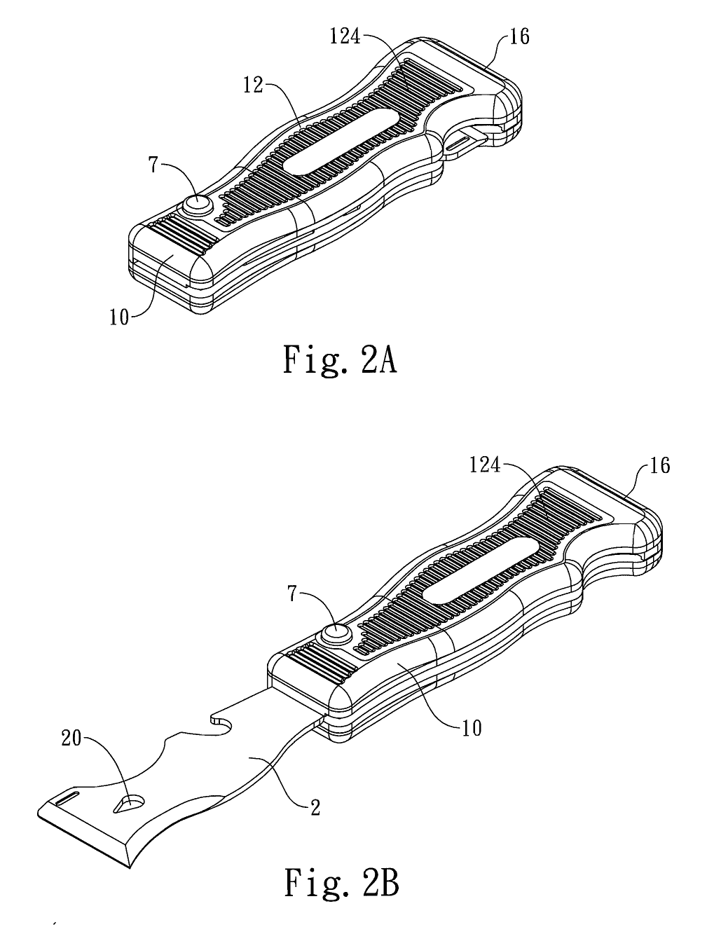

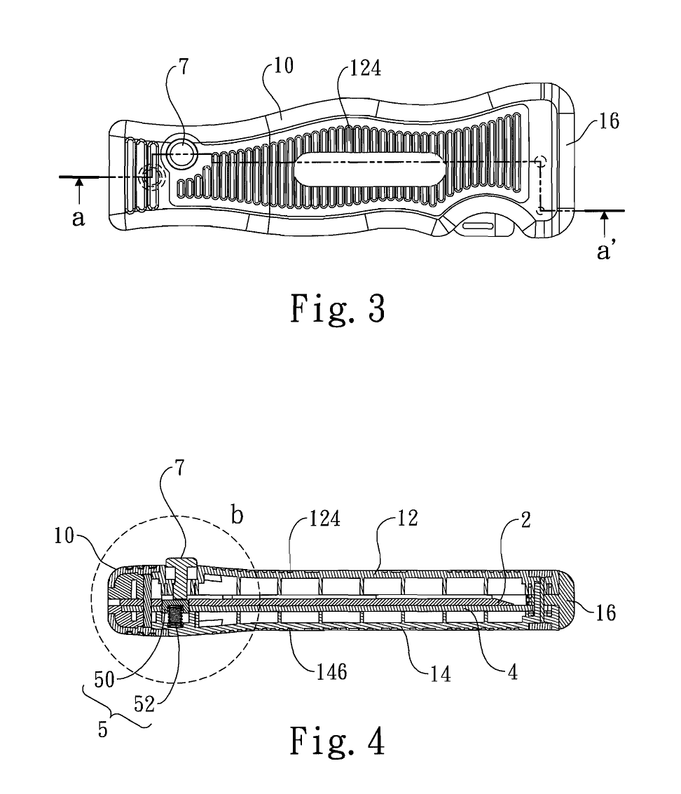

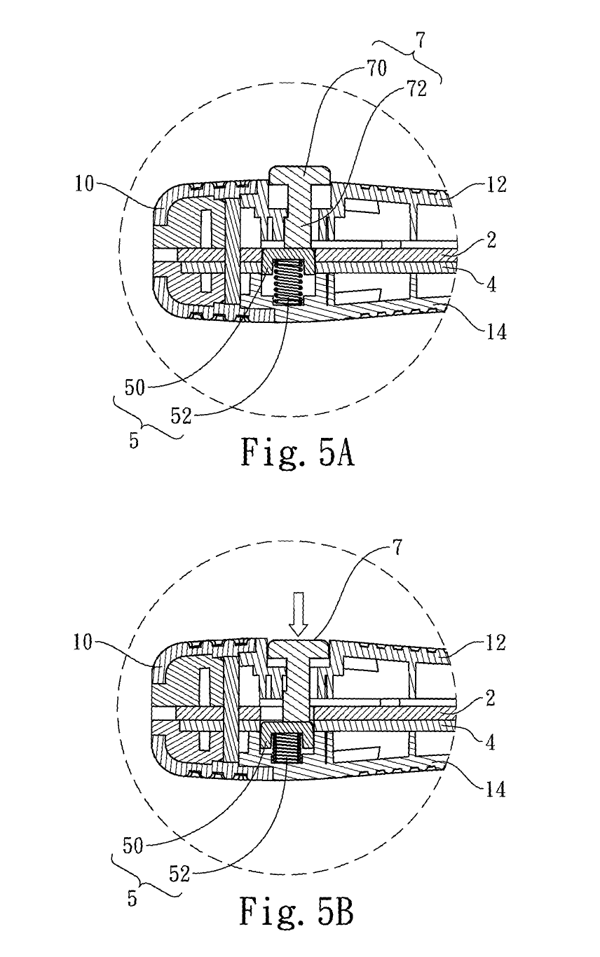

Please refer to FIGS. 1-5A that show a first preferred embodiment of the foldable putty knife according to the present invention. In this embodiment, the foldable putty knife comprises a hollow handle 1, a knife body 2, a reinforced sheet 4, an elastic stopper 5, a stopper-releasing button 7, and an elastic piece 8.

As shown in these figures, the hollow handle 1 comprises a casing 10, an upper cover 12, a lower cover 14, and a metal rear cover 16. The upper cover 12 and the lower cover 14 are respectively connected to the top and the bottom of the casing 10, and the rear metal cover 16 is connected to the rear parts of the casing 10, the upper cover 12, and the lower cover 14. In implementation, the metal rear cover 16 can be made by zinc alloy so as to obtain sufficient strength for being used as a hammer for hitting something.

On the top of one end of the upper cover 12 is provided with a first hole 120. Besides, the upper cover 12 has an external surface provided with skid-proof lines 124 and an internal surface provided with an upper recess 122. The lower cover 14 has an external surface provided with skid-proof lines 146 and an internal surface provided with a first recess 140, a lower recess 142, and a positioning groove 144. The first recess 140 is located correspondingly to the first hole 120, while the lower recess 142 is located correspondingly to the upper recess 122.

In implementation, the casing 10, the upper cover 12, and the lower cover 14 are all made by thermoplastic rubber. Besides, the skid-proof lines 124, 146 are made by polypropylene.

One end of the knife body 2 is provided with a hole for pivotal connection 22. Two positioning notches 24, 26 are respectively formed on the two sides adjacent to the hole for pivotal connection 22. Besides, a nail-drawing hole 20 is provided on another end of the knife body away from the end on which the hole for pivotal connection 22 is formed.

In this embodiment, the knife body 2 is pivotally connected between the upper cover 12 and the lower cover 14 via a shaft 3. The shaft 3 passes through the hole for pivotal connection 22 of the knife body 2 and two ends thereof are respectively engaged into the upper recess 122 of the upper cover 12 and the lower recess 142 of the lower cover 14. In implementation, the knife body 2 is made by high-carbon steel. Moreover, the nail-drawing hole 20 can be used to draw out nails during building construction.

The reinforced sheet 4 is located between the knife body 2 and the lower cover 14. One end of the reinforced sheet 4 is provided with a first opening 40 and a second opening 42. The second opening 42 is used for the shaft 3 to pass through. In implementation, the reinforced sheet can be made by metal material for supporting the knife body 2 thereon.

In this embodiment, the elastic stopper 5, the stopper-releasing button 7, and the elastic piece 8 are designed for users to control the movement of the knife body 2 out of or into the hollow handle 1. The elastic piece 8 is located in the positioning groove 144 of the lower cover 14, that is, in the position lateral to the knife body 2.

Moreover, a first stopper 60 and a second stopper 62 are respectively provided adjacent to the two lateral sides of the elastic stopper 5. Besides, the first and the second stoppers 60, 62 are respectively connected between the upper and the lower covers 12, 14.

The elastic stopper 5 has a stop portion 50 and an elastic portion 52. In this embodiment, the elastic portion 52 is a spring. In implementation, the elastic portion 52 is located in the first recess 140 of the lower cover 14 and passes through the first opening 40 of the reinforced sheet 4. The stop portion 52 is formed on the top of the elastic portion 50 and is used for being engaged with any one of the positioning notches 24, 26 in order to keep the knife body at a specific location.

The stopper-releasing button 7 has a pressing portion 70 and a vertical portion 72. The vertical portion 72 extends downwards from the bottom of the pressing portion 70. In implementation, the bottom of the vertical portion 72 is in contact with the top of the stop portion 50. Thereby, the force exerted for pressing the pressing portion 70 can be transferred to the elastic stopper 5 via the vertical portion 72, so that the elastic portion 52 is compressed.

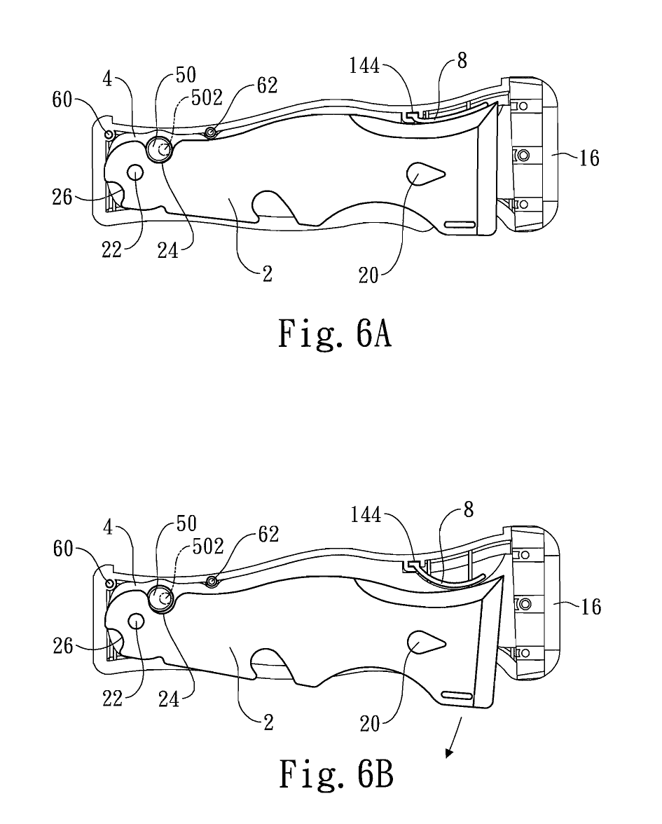

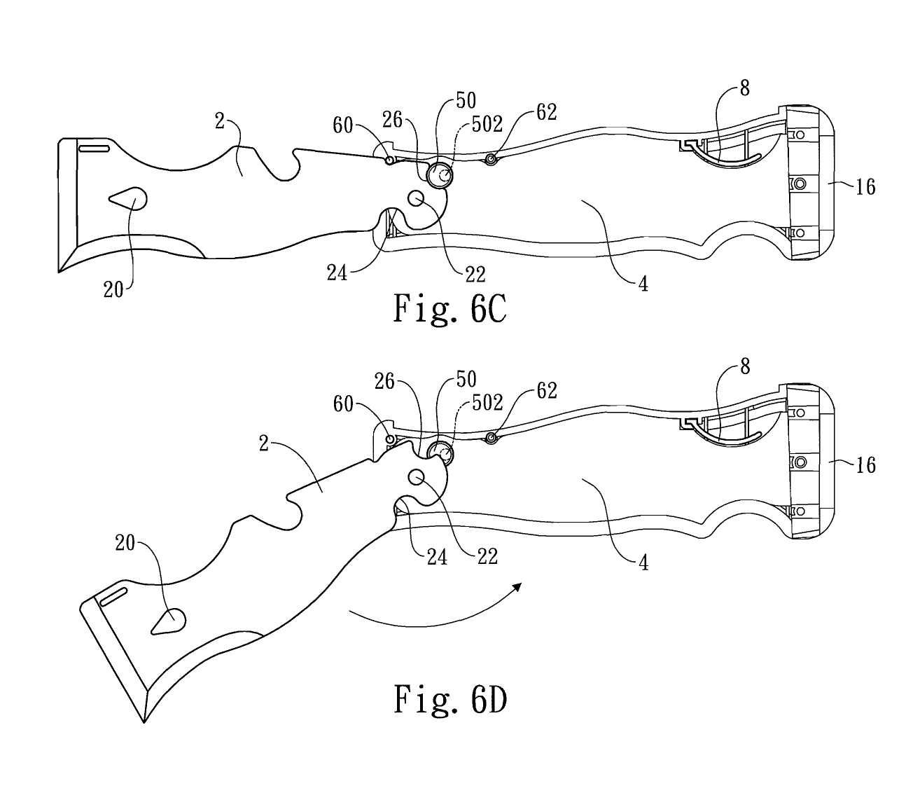

Please refer to FIGS. 5B and 6A-6D, in which is shown the use of the foldable putty knife according to the present invention. As shown in FIGS. 5B and 6A, the knife body 2 is located inside the hollow handle 1. In this case, the stop portion 50 of the elastic stopper 5 is engaged into the positioning notch 24 of the knife body 2, so as to hold the knife body 2 at the present location. At this present moment, the elastic piece 8 is in the compressed state. Besides, the vertical portion 72 is in contact with the top of the stop portion 50 at an eccentric position 502.

When users press the stopper-releasing button 7, the elastic portion 52 of the elastic stopper 5 is compressed, and consequently the elastic stopper 5 leaves its original position at which it is engaged with the positioning notch 24 and is temporarily located beneath the knife body 2. At this moment, as shown in FIG. 6B, as soon as the limitation on the knife body 2 is released, the compressed elastic piece 8 will restore its original state and consequently provide elastic force to eject the knife body 2 out of the hollow handle 1 along the direction of the arrow.

When the knife body 2 is ejected out of the hollow handle 1, as shown in FIG. 6C, users can move the knife body 2 to a full extent of 180 degrees out of the hollow handle 1 by means of manual operation. At this moment, the positioning notch 26 of the knife body 2 will take the place of the positioning notch 24 and the elastic stopper 5 beneath the knife body 2 will be engaged into the positioning notch 26. Thereby, the knife body 2 can be held at the present position. Moreover, when the knife body 2 is at the present position, its further movement can be prevented by means of the first stopper 60.

The knife body 2 can be moved into the hollow handle 1 again by pressing the stopper-releasing button 7 in order to compress the elastic portion 52 of the elastic stopper 5 and have the elastic stopper 5 left its original position at which it is engaged into the positioning notch 26 and temporarily located beneath the knife body 2.

In this case, as shown in FIG. 6D, the knife body 2 can be manually moved into the hollow handle 1 along the direction of the arrow as soon as the limitation on the knife body 2 is released. With the movement of the knife body 2, the elastic piece 8 is gradually compressed again until the positioning notch 24 of the knife body 2 is back to its original position and the elastic stopper 5 is re-engaged into the positioning notch 24. Thereby, the knife body 2 is held in the hollow handle 1 again. Besides, when the knife body 2 is located inside the hollow handle 1, its further movement can be prevented by means of the second stopper 62.

As disclosed in the above description and attached drawings, the present invention can provide a foldable putty knife of convenient use, where the knife body can be rendered movable by pressing the stopper-releasing button and can be ejected automatically out of the hollow handle by elastic force provided by the elastic piece. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A foldable putty knife, comprising:
a hollow handle, having one end provided with a first hole on the top thereof and two lateral sides respectively provided with an opening;
a knife body, having one end pivotally connected to the hollow handle's interior via a shaft and two positioning notches provided respectively at two sides adjacent to the pivotally-connected end;
an elastic stopper, provided inside the hollow handle and adapted for being engaged with one of the two positioning notches;
a stopper-releasing button, fitted into the first hole in the way that its bottom is against the elastic stopper's top for compressing the elastic stopper in order to detach the elastic stopper from the engaged positioning notch; and
an elastic piece, provided inside the hollow handle and adapted for providing elastic force to move the knife body out of the hollow handle.

2. The foldable putty knife as claimed in claim 1, wherein the hollow handle further comprises a casing, an upper cover, and a lower cover; the upper and lower covers are respectively connected to the casing's top and bottom and are engageable with each other.

3. The foldable putty knife as claimed in claim 2, wherein the hollow handle further comprises a metal rear cover, and the metal rear cover is connected to the rear parts of the casing, the upper cover, and the lower cover.

4. The foldable putty knife as claimed in claim 3, wherein the metal rear cover is made by zinc alloy.

5. The foldable putty knife as claimed in claim 2, further comprising a reinforced sheet, wherein the reinforced sheet is provided between the lower cover and the knife body and has one end provided with two openings through which the shaft and the elastic stopper pass through respectively.

6. The foldable putty knife as claimed in claim 2, wherein external surfaces of the upper and lower covers are respectively provided with skid-proof lines.

7. The foldable putty knife as claimed in claim 6, wherein the skid-proof lines are made by polypropylene.

8. The foldable putty knife as claimed in claim 1, wherein the knife body is further provided with a nail-drawing hole.

9. The foldable putty knife as claimed in claim 1, wherein the hollow handle is made by thermoplastic rubber.

10. The foldable putty knife as claimed in claim 1, wherein the knife body is made by high-carbon steel.
